(19) United States
(12) Patent Application Publication
(10) Pub. No.: US 2022/0283353 A1
(43) Pub. Date: Sep. 8, 2022

(54) FINGERPRINT SENSING APPARATUS

(71) Applicant: Egis Technology Inc., Hsinchu City (TW)

(72) Inventor: Chao-Yi Yeh, Hsinchu City (TW)

(73) Assignee: Egis Technology Inc., Hsinchu City (TW)

(21) Appl. No.: 17/634,552

(22) PCT Filed: Apr. 7, 2020
(86) PCT No.: PCT/CN2020/083456

§ 371 Date: Feb. 11, 2022

Related U.S. Application Data
(60) Provisional application No. 62/887,687, filed on Aug. 16, 2019.

(51) Int. Cl. F21V 8/00; G06V 40/13; G06F 3/042; G06F 3/041

(52) U.S. Cl. CPC G02B 6/0005; G06V 40/1318; G06F 3/0421; G06F 3/0412

(57) ABSTRACT

A fingerprint sensing apparatus adapted to sense a fingerprint of a user. The fingerprint sensing device includes an image sensor (110), a light source (120) and a light guide plate (130). The image sensor (110) is provided on a first side (S1) of the light guide plate (130), and the light source (120) is provided on a second side (S2) of the light guide plate (130). The first side (S1) is opposite to the second side (S2). The light guide plate (130) includes a plurality of optical fiber devices (132), each optical fiber device (132) including a fingerprint end (E1) adjacent to the fingerprint and a sensing end (E2) adjacent to the image sensor (110). Cross-sectional areas of fiber cores (132a) of the optical fiber devices decrease from the fingerprint end (E1) to the sensing end (E2). The fingerprint sensing apparatus can have a good optical quality with a thin volume.

### TECHNICAL FIELD

The invention relates to a fingerprint sensing apparatus.

### RELATED ART

As biometric recognition technologies have gradually become mature, many different biometric characteristics are applied to recognize identities of users. Due to the good recognition rate and accuracy, fingerprint recognition technologies are applied in the most extensive manner, wherein optical fingerprint recognition has advantages in cost and thus is the mainstream of the fingerprint recognition technologies at present.

The principle of the existing optical fingerprint recognition technology is to project light by a light source and transmit the light to a fingerprint by a light guide device, the fingerprint on a finger reflects the light to again transmit the light back to a sensor by the light guide device, and the sensor then senses patterns of the fingerprint according to the reflected light and compares the patterns with fingerprint images stored in the system, so as to achieve the recognition function.

However, the existing optical fingerprint recognition technology is still unable to achieve good image contrast, fingerprint image brightness, and fingerprint recognition rate while the volume is relatively thin. Therefore, how to solve the above problems has become one of the goals that people in the art endeavor to accomplish.

### SUMMARY OF THE INVENTION

In view of the above, the invention provides a fingerprint sensing apparatus which may have good optical quality with a relatively thin volume.

According to an embodiment of the invention, a fingerprint sensing apparatus which is adapted to sense a fingerprint of a user and includes an image sensor, a light source, and a light guide plate is provided. The image sensor is disposed at a first side of the light guide plate, and the light source is disposed at a second side of the light guide plate. The first side is opposite to the second side. The light guide plate includes a plurality of optical fiber devices, each of which includes a fingerprint end adjacent to the fingerprint and a sensing end adjacent to the image sensor. Cross-sectional areas of fiber cores of the optical fiber devices decrease from the fingerprint end to the sensing end.

In the fingerprint sensing apparatus provided in the embodiments of the invention, a cross-sectional area of the fiber core of the optical fiber devices in the light guide plate decreases from the fingerprint end to the sensing end, and therefore light beams emitted from the sensing end are concentrated to a greater extent; accordingly, fingerprint images sensed by the image sensor are of good quality. In addition, the fingerprint sensing apparatus occupies a relatively small volume, which complies with the current trend of miniaturization of electronic apparatuses.

### DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a fingerprint recognition apparatus according to an embodiment of the invention.

FIG. 2A is a schematic top view of the light guide plate of FIG. 1 at a fingerprint end.

FIG. 2B is a schematic top view of the light guide plate of FIG. 1 at a sensing end.

FIG. 3 is a schematic view of an external appearance of a fiber core of the optical fiber device in FIG. 1.

FIG. 4A is a schematic top view, a schematic cross-sectional view, and a corresponding optical simulation diagram of optical fiber devices at a fingerprint end and a sensing end according to a comparative embodiment.

FIG. 4B is a schematic top view, a schematic cross-sectional view, and a corresponding optical simulation diagram of optical fiber devices at a fingerprint end and a sensing end according to an embodiment of the invention.

FIG. 5A is a schematic top view of a portion of a light guide plate at a fingerprint end according to another embodiment of the invention.

FIG. 5B is a schematic top view of a portion of the light guide plate depicted in FIG. 5A at a sensing end.

FIG. 6 is a schematic view of an external appearance of a fiber core of the optical fiber device in FIG. 5A.

### EXPLANATION OF REFERENCE NUMBER OF DRAWINGS

100: image recognition apparatus;
110: image sensor;
120: light source;
130, 130a: light guide plate;
132, 132′: optical fiber device
132a, 132a′, 132aa: fiber core;
132b, 132b′, 132ba covering part;
140 transparent cover plate;
A1, A2 cross section;
C1, C2 center of figure;
D′, D1, D2 distance;
E1 fingerprint end;
E2 sensing end;
D3 light beam;
P1, P2 position;
RB reflected light beam;
OB finger;
S side surface;
S1 first side;
S2 second side;
W′, W1a, W2a, Wb1, Wb2: width

### DESCRIPTION OF THE EMBODIMENTS

Reference will now be made in detail to exemplary embodiments of the disclosure, and examples of the exemplary embodiments are illustrated in the accompanying drawings. Whenever possible, the same reference numerals are used in the drawings and descriptions to indicate the same or similar parts.

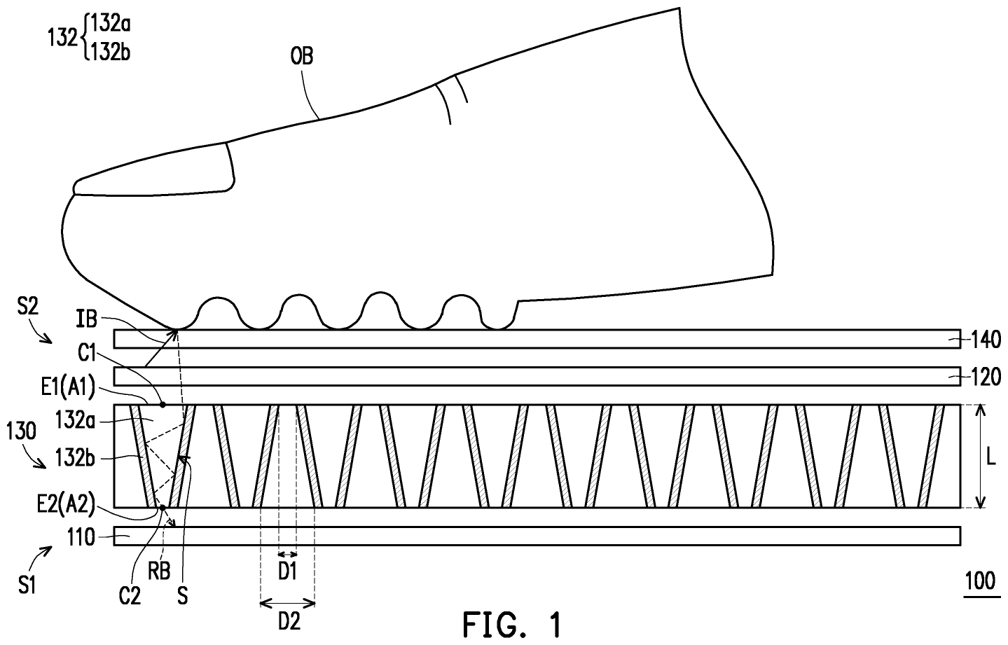

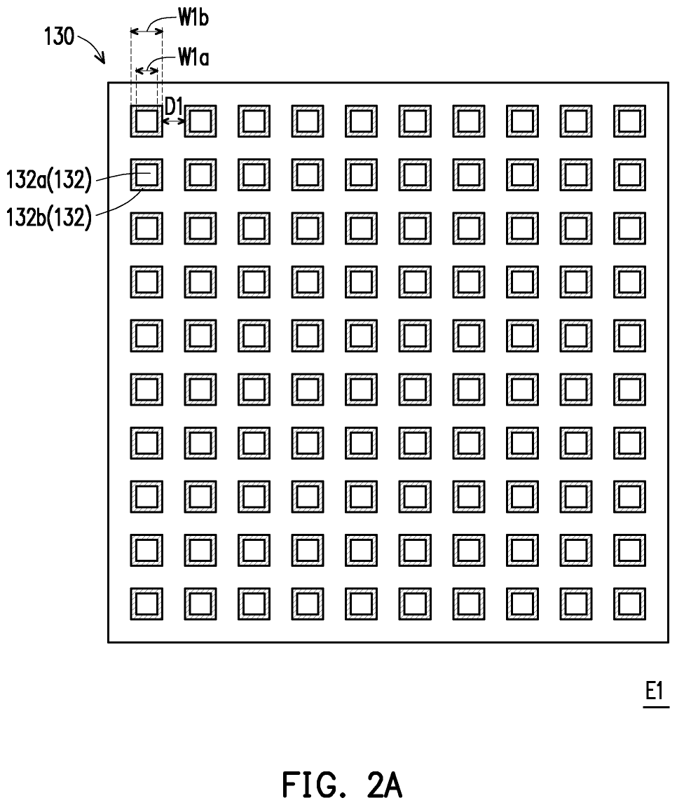

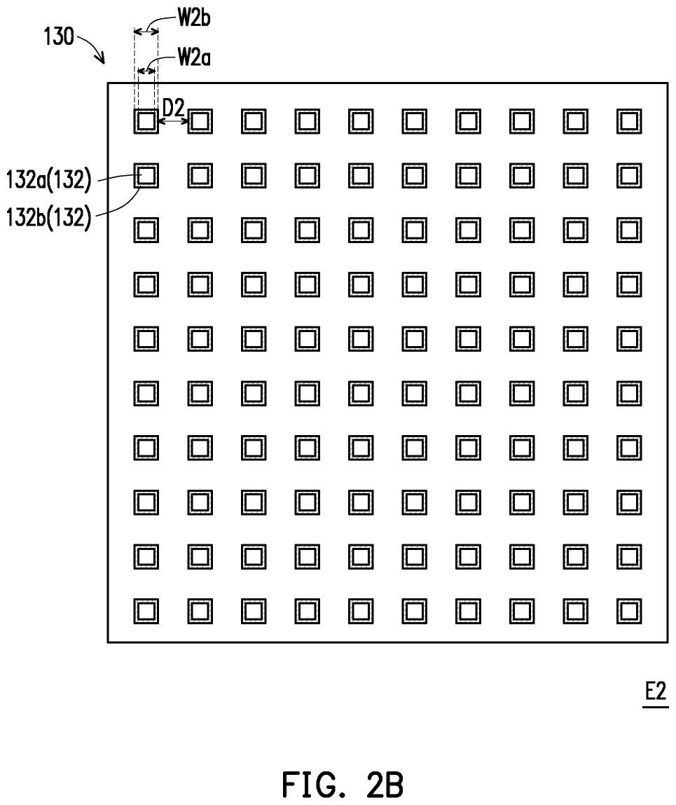

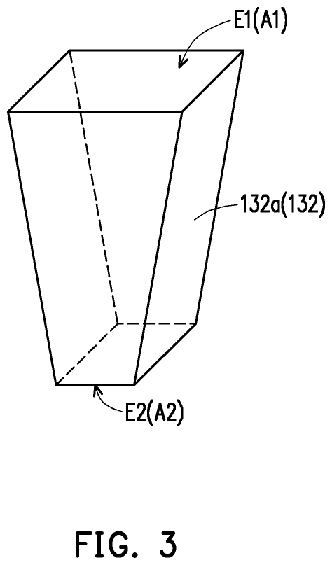

FIG. 1 is a schematic view of a fingerprint recognition apparatus according to an embodiment of the invention. FIG. 2A is a schematic top view of the light guide plate of FIG. 1 at a fingerprint end. FIG. 2B is a schematic top view of the light guide plate of FIG. 1 at a sensing end. FIG. 3 is a schematic view of an external appearance of a fiber core of the optical fiber device in FIG. 1.

Please refer to FIG. 1. In this embodiment, the fingerprint recognition apparatus 100 includes an image sensor 110, a light source 120, a light guide plate 130, and a transparent cover plate 140 and is adapted to sense fingerprints of users. In the following paragraphs, relationships of arrangement of said devices will be explained in detail.

The image sensor 110 is an electronic device which may convert an optical signal into an electrical signal, thereby converting an image beam coming from an object into image data. In this embodiment, the type of the image sensor 110 is, for instance, a thin film transistor image sensor or other suitable image sensors, and the invention is not limited to what is described herein. The image sensor 110 is disposed at a first side S1 (e.g., a lower side) of the light guide plate 130.

The light source 120 is an optoelectronic device capable of emitting light beams. In this embodiment, the light source 120 may be a display panel. In other embodiments, the light source 120 may also be a light emitting diode, an organic light emitting diode, or other suitable light emitting devices, and the invention is not limited to what is described herein. The light source 120 is disposed at a second side S2 (e.g., an upper side) of the light guide plate 130, and the light source 120 is disposed between the transparent cover plate 140 and the light guide plate 130.

The light guide plate 130 is a plate-shaped device composed of a plurality of optical fiber devices 132, wherein light beams are adapted to be transmitted in the optical fiber devices 132. Please refer to FIG. 1, FIG. 2A to FIG. 2B, and FIG. 3, each of the optical fiber devices 132 includes a fiber core 132a and a covering part 132b, wherein the covering part 132b covers the fiber core 132a. That is, an inner surface of the covering part 132b and an exterior surface of the fiber core 132a are conformal. A refractive index of the fiber core 132a is greater than a refractive index of the covering part 132b. Each of the optical fiber devices 132 includes a fingerprint end E1 adjacent to the fingerprint and a sensing end E2 adjacent to the image sensor 110. Please refer to FIG. 2A and FIG. 2B. These optical fiber devices 132 are arranged in an array and correspond to each pixel unit (not shown) of the image sensor 110. In the fingerprint end E1 and the sensing end E2, there are distances D1 and D2 between two adjacent optical fiber devices 132, respectively, wherein the distance D1 is, for instance, 3 micrometers, and the distance D2 is, for instance, 4 micrometers. Note that the above-mentioned numeric values are merely exemplary, and the invention is not limited to what is described herein.

The fiber core 132a has a cross section A1 at the fingerprint end E1, a cross section A2 at the sensing end E2, and a side surface S connected to the cross sections A1 and A2, where the side surface S is, for instance, a bevel surface. A center C1 of figure of the cross section A1 of the fiber core 132a at the fingerprint end E1 is aligned to the center C2 of figure of the cross section A2 of the fiber core 132a at the sensing end E2. It can be derived from FIG. 2A and FIG. 2B that the area of the cross section A1 of the fiber core 132a at the fingerprint end E1 is larger than the area of the cross section A2 of the fiber core 132a at the sensing end E2. In detail, please refer to FIG. 2A. In this embodiment, the shape of the cross section A1 of the fiber core 132a at the fingerprint end E1 is a square, and its width W1a is, for instance, 8 micrometers. That is, the area of the cross section A1 of the fiber core 132a at the fingerprint end E1 is, for instance, 64 square micrometers. Please refer to FIG. 2B. The shape of the cross section A2 of the fiber core 132a at the sensing end E2 is a square, and its width W2a is, for instance, 6 micrometers. That is, the area of the cross section A2 of the fiber core 132a at the sensing end E2 is, for instance, 64 square micrometers. It can be derived from FIG. 1 and FIG. 3 that the area of the fiber core 132a decreases in a direction from the fingerprint end E1 to the sensing end E2, and the shape of the fiber core 132a is a truncated pyramid. Note that the above-mentioned numeric values are merely exemplary, and the invention is not limited to what is described herein.

On the other hand, the shape of a cross section of the covering part 132b at the fingerprint end E1 is a hollow square, and its width Wb1 is, for instance, 9 micrometers; that is, the cross-sectional area of the covering part 132b at the fingerprint end E1 is, for instance, 17 square micrometers. The shape of a cross section of the covering part 132b at the sensing end E2 is a hollow square, and its width Wb2 is, for instance, 7 micrometers; that is, the cross-sectional area of the covering part 132b at the fingerprint end E1 is, for instance, 13 square micrometers. It can be derived from FIG. 1 that the area of the covering part 132b decreases in a direction from the fingerprint end E1 to the sensing end E2. Note that the above-mentioned numeric values are merely exemplary, and the invention is not limited to what is described herein.

Besides, in the light guide plate 130, in the direction from the fingerprint end E1 to the sensing end E2, a length L of the optical fiber devices 132 falls within a range of 4 micrometers to 10 micrometers, but the invention is not limited to what is described herein.

The transparent cover plate 140 is an optical device that allows the light beam to pass through, and a material of the transparent cover plate 140 is glass, for instance; additionally, the transparent cover plate 140 provides the above-mentioned function of protecting the devices. The transparent cover plate 140 is disposed at the second side S2 of the light guide plate 130.

Optical effects achieved in this embodiment will be explained in detail in the following paragraphs.

When a finger OB of a user touches the transparent cover plate 140, the light source 120 emits a light beam IB, the light beam D3 passes through the transparent cover plate 140 and is transmitted to the fingerprint on the finger OB, and the fingerprint reflects the light beam D3 to form a reflected light beam RB, wherein the reflected light beam RB has graphical information of the fingerprint. The reflected light beam RB then enters the fiber cores 132a of the optical fiber devices 132 from the fingerprint end E1, a total reflection of the reflected light beam RB is performed once or multiple times in the fiber cores 132a, and the reflected light beam RB leaves the fiber cores 132a from the sensing end E2, so to be transmitted to the image sensor 110. After the image sensor 110 receives the reflected light beam RB, the image sensor 110 converts the light signal into an electrical signal to sense patterns of the fingerprint and compare the patterns with fingerprint images stored in the system to achieve the recognition function.

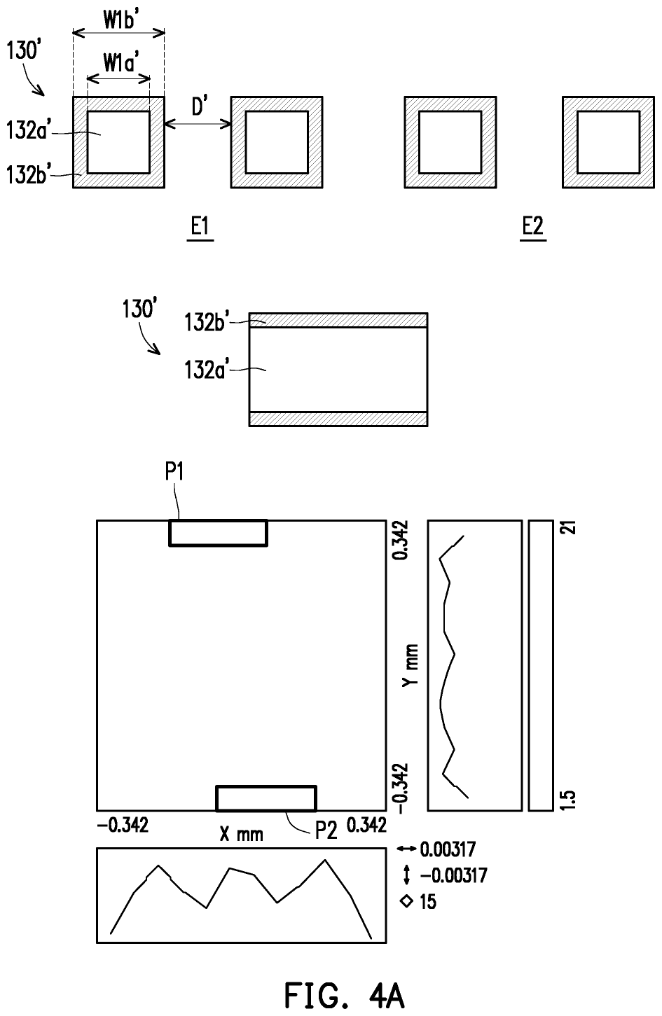

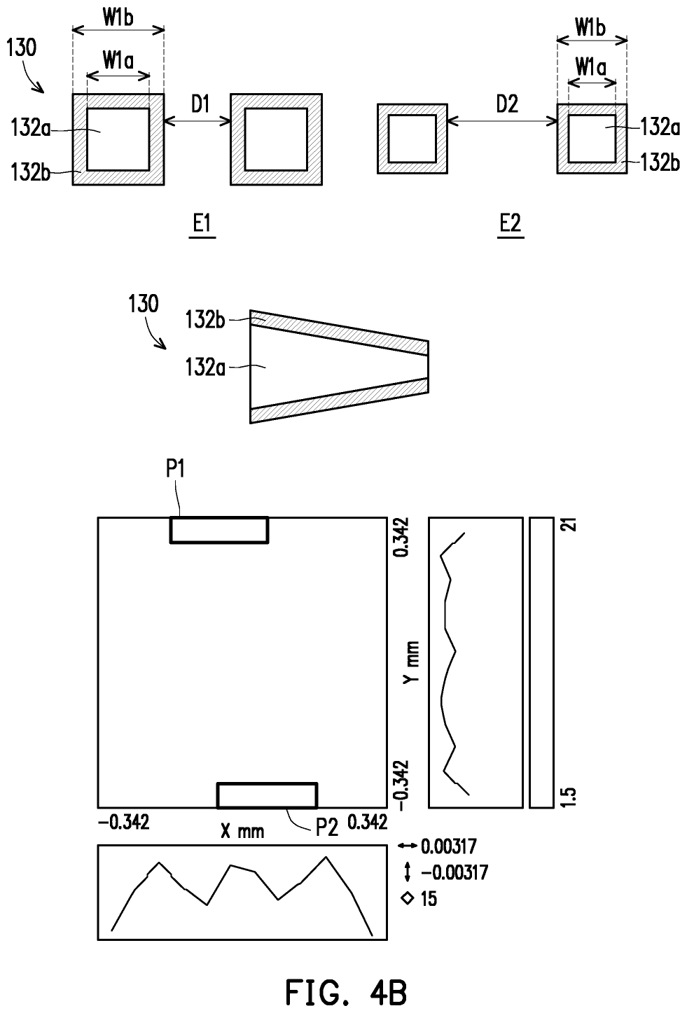

FIG. 4A is a schematic top view, a schematic cross-sectional view, and a corresponding optical simulation diagram of optical fiber devices at a fingerprint end and a sensing end according to a comparative embodiment. FIG. 4B is a schematic top view, a schematic cross-sectional view, and a corresponding optical simulation diagram of optical fiber devices at a fingerprint end and a sensing end according to an embodiment of the invention.

Differences between the optical fiber devices 132′ provided in the comparative embodiment and the optical fiber devices 132 provided in this embodiment are specifically described, and the main difference lies in that the optical fiber devices 132′ include fiber cores 132a′ and covering parts 132b ‘, as shown in FIG. 4A. The shape of the fiber cores 132a’ is a rectangular cylinder, and the shape of the covering parts 132b′ is a hollow rectangular cylinder. The shape of cross sections of the fiber cores 132a′ at both the fingerprint end E1 and the sensing end E2 is a square, and a width W′ thereof is, for instance, 6 micrometers. A width W″ of the covering parts 132b′ at both the fingerprint end E1 and the sensing end E2 is, for instance, 7 micrometers. The shape of cross sections of the covering parts 132b′ at both the fingerprint end E1 and the sensing end E2 is a hollow square, and the width W′ thereof is, for instance, 6 micrometers. A distance D′ between two adjacent optical fiber devices 130′ is, for instance, 3 micrometers. It should be noted that the above-mentioned numerical values are only examples, and the invention is not limited to what is described herein.

Please refer to FIG. 4A. In the comparative embodiment, it can be derived from calculations that an optical efficiency is about 5.5%, an image contrast at a position P1 is 21.22%, and an image contrast at a position P2 is 20.7%. Please refer to FIG. 4B. In this embodiment, it can be derived from calculations that the optical efficiency is about 8.71%, the image contrast at the position P1 is 22.47%, and the image contrast at the position P2 is 22%. Accordingly, compared to the design of the fiber cores 13a provided in the comparative embodiment, the fiber cores 132a of the optical fiber devices 132 provided in this embodiment have the cross-sectional area decreasing from the fingerprint end E1 to the sensing end E2, the light concentration degree of the reflected light beam RB emitted from the sensing end E2 is relatively high, and thus the optical efficiency of the fingerprint image sensed by the image sensor 110 is good. Besides, the fingerprint sensing apparatus 100 occupies a relatively small volume, which complies with the current trend of miniaturization of electronic apparatuses.

It is worth mentioning that if a stray light beam not coming from the finger OB is transmitted into the fiber core 132a, the side surface S of the fiber core 132a is a bevel surface, and thus the stray light beam may be reflected by the side surface and emitted out of the optical fiber device 132 from the fingerprint end E1, which may reduce an optical cross talk phenomenon of the stray light beam. As such, the image contrast of the fingerprint sensed by the image sensor 110 is good, and thereby the fingerprint recognition rate is further improved.

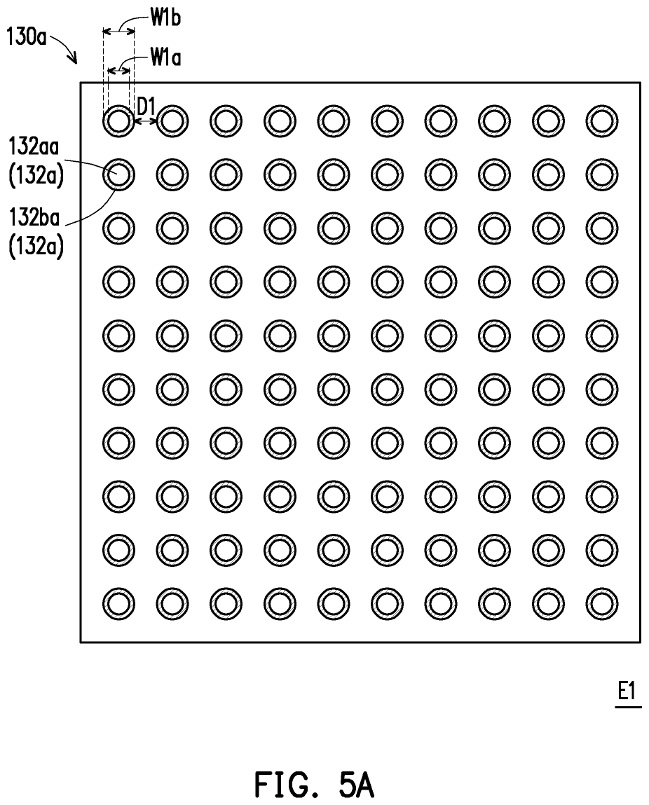

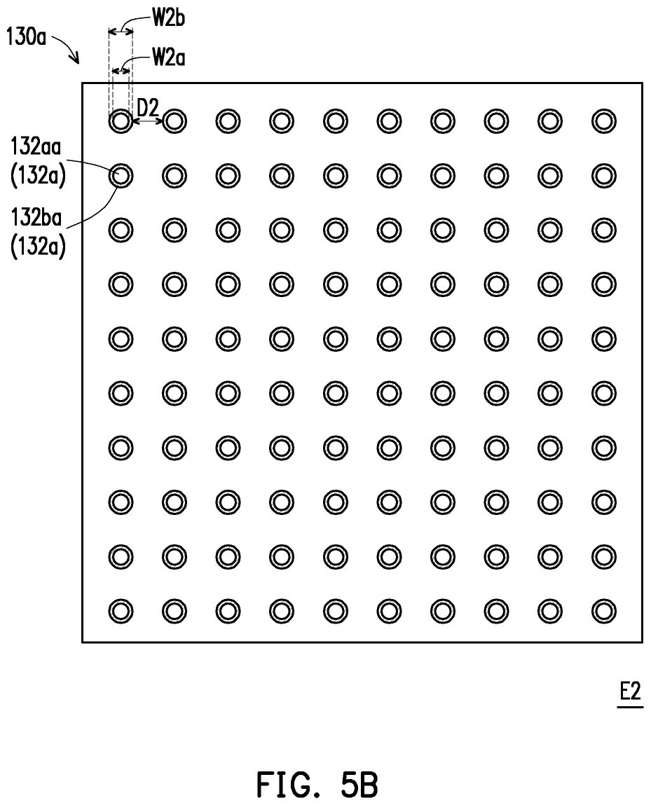

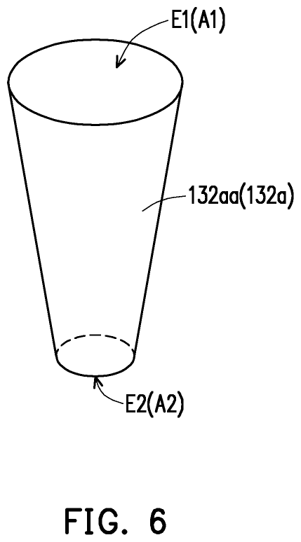

FIG. 5A is a schematic top view of a portion of a light guide plate at a fingerprint end according to another embodiment of the invention. FIG. 5B is a schematic top view of a portion of the light guide plate depicted in FIG. 5A at a sensing end. FIG. 6 is a schematic view of an external appearance of a fiber core of the optical fiber device in FIG. 5A.

Please refer to FIG. 5A to FIG. 5B and FIG. 6. A light guide plate 130a in these figures is similar to the light guide plate 130 depicted in FIG. 1, FIG. 2A to FIG. 2B, and FIG. 3, while the main difference lies in that the shape of fiber cores 132aa of the light guide plate 130a is a truncated cone, and the shape of covering parts 132ba is a hollow truncated cone.

It is worth mentioning that as long as the cross-sectional area of the fiber core meets the condition of decreasing from the fingerprint end E1 to the sensing end E2, it falls within the scope of the invention, and the invention is not limited to what is described herein.

To sum up, in the fingerprint sensing apparatus provided in the embodiments of the invention, the cross-sectional areas of the fiber cores of the optical fiber devices in the light guide plate decrease from the fingerprint end to the sensing end, and therefore the light beams emitted from the sensing end are concentrated to a greater extent; accordingly, the fingerprint images sensed by the image sensor are of good quality. In addition, the fingerprint sensing apparatus occupies a relatively small volume, which complies with the current trend of miniaturization of electronic apparatuses. In addition, because the side surfaces of the fiber cores are the bevel surfaces, when the stray light beam enters the fiber cores, the stray light beam may be reflected on the bevel surfaces multiple times and emitted from the fingerprint end, which prevents the image sensor at the sensing end from receiving the stray light beam. As a result, the fingerprint sensing apparatus has a good image contrast.

Finally, it should be explained that the above embodiments merely serve to explain the technical solutions of the invention and are not construed as limitations to the invention. Although the invention has been explained in detail with reference to the foregoing embodiments, those of ordinary skill in the art should understand that modifications may be made to the technical solutions described in the foregoing embodiments, or equivalent replacements of some or all of the technical features may be done; however, these modifications or replacements do not cause the essence of the corresponding technical solutions to deviate from the scope of the technical solutions provided in the embodiments of the invention.

What is claimed is:

1. A fingerprint sensing apparatus, adapted to sense a fingerprint of a user and characterized in comprising:
an image sensor;
a light source; and
a light guide plate, wherein the image sensor is disposed at a first side of the light guide plate, the light source is disposed at a second side of the light guide plate, and the first side is opposite to the second side, wherein the light guide plate comprises a plurality of optical fiber devices, wherein each of the optical fiber devices comprises a fingerprint end adjacent to the fingerprint and a sensing end adjacent to the image sensor, wherein cross-sectional areas of fiber cores of the optical fiber devices decrease from the fingerprint end to the sensing end.

2. The fingerprint sensing apparatus according to claim 1, characterized in that a shape of the fiber cores of the optical fiber devices is a truncated pyramid.

3. The fingerprint sensing apparatus according to claim 1, characterized in that a shape of the fiber cores of the optical fiber devices is a truncated cone.

4. The fingerprint sensing apparatus according to claim 1, characterized in that a length of the optical fiber devices falls within a range of 4 micrometers to 10 micrometers in a direction from the fingerprint end to the sensing end.

5. The fingerprint sensing apparatus according to claim 1, characterized in that a center of figure of a cross section of the fiber core at the fingerprint end is aligned to a center of figure of a cross section of the fiber core at the sensing end.

6. The fingerprint sensing apparatus according to claim 1, characterized in that the image sensor is a thin film transistor image sensor.

7. The fingerprint sensing apparatus according to claim 1, characterized in that the light source comprises a display panel.

8. The fingerprint sensing apparatus according to claim 1, characterized in that the light source is configured to emit a light beam, wherein the light beam is transmitted to the fingerprint, the fingerprint reflects the light beam to form a reflected light beam, and the reflected light beam enters the optical fiber devices from the fingerprint end and leaves the optical fiber devices from the sensing end, so as to be transmitted to the image sensor.

9. The fingerprint sensing apparatus according to claim 1, characterized in further comprising a transparent cover plate disposed above the light source.

10. The fingerprint sensing apparatus according to claim 1, characterized in that the optical fiber devices are arranged in an array.
